(19) United States
(12) Patent Application Publication
(10) Pub. No.: US 2023/0114556 A1
(43) Pub. Date: Apr. 13, 2023

(54) NEURAL NETWORK MODELS USING PEER-ATTENTION

(71) Applicant: Google LLC, Mountain View, CA (US)

(72) Inventors: Michael Sahngwon Ryoo, Mountain View, CA (US); Anthony Jacob Piergiovanni, Nazareth, PA (US); Anelia Angelova, Sunnyvale, CA (US)

(21) Appl. No.: 17/909,581

(22) PCT Filed: Jul. 14, 2021
(86) PCT No.: PCT/US2021/041583

§ 371 Date: Sep. 6, 2022

Related U.S. Application Data
(60) Provisional application No. 63/051,554, filed on Jul. 14, 2020.

(51) Int. Cl. G06V 10/82; G06V 10/26

(52) U.S. Cl. CPC G06V 10/82; G06V 10/26

(57) ABSTRACT

Methods, systems, and apparatus, including computer programs encoded on a computer storage medium, for processing a network input using a neural network to generate a network output. In one aspect, a method comprises processing a network input sing a neural network to generate a network output, where the neural network has multiple blocks, wherein each block is configured to process a block input to generate a block output, the method comprising, for each target block of the neural network: generating attention-weighted representations of multiple first block outputs, comprising, for each first block output: processing multiple second block outputs to generate attention factors; and generating the attention-weighted representation of each first block output by applying the respective attention factors to the corresponding first block output; and generating the target block input from the attention-weighted representations; and processing the target block input using the target block to generate a target block output.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations for processing a network input using a neural network to generate a network output. The neural network implements a “peer-attention” mechanism, i.e., where the outputs of one or more blocks in the neural network are processed to generate a set of attention factors that are applied to the channels of an input to another block in the neural network. A “block” refers to a group of one or more neural network layers.

According to a first aspect there is provided method performed by one or more data processing apparatus for processing a network input using a neural network to generate a network output, wherein the neural network comprises a plurality of blocks that each include one or more respective neural network layers, wherein each block is configured to process a respective block input to generate a respective block output, the method comprising, for each of one or more target blocks of the neural network: generating a target block input to the target block, comprising: receiving a respective first block output of each of one or more respective first blocks, wherein each first block output comprises a plurality of channels, wherein the first block outputs are generated by the first blocks during processing of the network input by the neural network; generating a respective attention-weighted representation of each first block output, comprising, for each first block output: receiving a respective second block output of each of one or more second blocks, wherein at least one of the second block outputs is different than the first block output, wherein the second block outputs are generated by the second blocks during processing of the network input by the neural network; processing the second block outputs to generate a respective attention factor corresponding to each channel of the first block output; and generating the attention-weighted representation of the first block output by applying each attention factor to the corresponding channel of the first block output; and generating the target block input from at least the attention-weighted representations of the first block outputs; and processing the target block input using the target block to generate a target block output.

In some implementations, processing the second block outputs to generate a respective attention factor corresponding to each channel of the first block output comprises: generating a combined representation by combining the second block outputs using a set of attention weights, wherein each attention weight corresponds to a respective second block output; processing the combined representation using one or more neural network layers to generate the respective attention factor corresponding to each channel of the first block output.

In some implementations, generating the combined representation by combining the second block outputs using the set of attention weights comprises: scaling each second block output by a function of the corresponding attention weight; and determining the combined representation based on a sum of the scaled second block outputs.

In some implementations, processing the combined representation using one or more neural network layers to generate the respective attention factor corresponding to each channel of the first block output comprises: processing the combined representation using a pooling layer that performs global average pooling over spatial dimensions of the combined representation; and processing an output of the pooling layer using a fully connected neural network layer.

In some implementations, values of the attention weights are learned during training of the neural network.

In some implementations, generating the attention-weighted representation of the first block output by applying each attention factor to the corresponding channel of the first block output comprises: scaling each channel of the first block output by the corresponding attention factor.

In some implementations, generating the target block input from at least the attention-weighted representations of the first block outputs comprises: combining the attention-weighted representations of the first block outputs using a set of connection weights, wherein each connection weight corresponds to a respective attention-weighted representation of a first block output.

In some implementations, combining the attention-weighted representations of the first block outputs using the set of connection weights comprises: scaling each attention-weighted representation of a first block output by a function of the corresponding connection weight.

In some implementations, values of the connection weights are learned during training of the neural network.

In some implementations, each block in the neural network is associated with a respective level in a sequence of levels; and for each given block that is associated with a given level that follows a first level in the sequence of levels, the given block only receives block outputs from other blocks that are associated with levels that precede the given level.

In some implementations, the target block is associated with a target level, and the target block receives: (i) a respective first block output of each first block that is associated with a level that precedes the target level, and (ii) a respective second block output of each second block that is associated with a level that precedes the target level.

In some implementations, the neural network performs a video processing task.

In some implementations, the network input comprises a plurality of video frames.

In some implementations, the network input further comprises data defining one or more segmentation maps, wherein each segmentation map corresponds to a respective video frame and defines a segmentation of the video frame into one or more object classes.

In some implementations, the network input further comprises a plurality of optical flow frames corresponding to the plurality of video frames.

In some implementations, the neural network comprises a plurality of input blocks, wherein each input block includes one or more respective neural network layers, wherein the plurality of input blocks comprise: (i) a first input block that processes the plurality of video frames, and (ii) a second input block that processes the one or more segmentation maps.

In some implementations, each block of the plurality of blocks is configured to process a block input at a respective temporal resolution.

In some implementations, each block comprises one or more dilated temporal convolutional layers having a temporal dilation rate corresponding to the temporal resolution of the block.

In some implementations, each block of the plurality of blocks is a space-time convolutional block that comprises one or more convolutional neural network layers.

In some implementations, the neural network generates the network output by processing the target block outputs.

Particular embodiments of the subject matter described in this specification can be implemented so as to realize one or more of the following advantages.

This specification describes a neural network that implements a “peer-attention” mechanism, i.e., where the outputs of one or more blocks in the neural network are processed to generate a set of attention factors that are applied to the channels of an input to another block in the neural network. Generally, the outputs of different blocks in the neural network can encode different information at various levels of abstraction. Using peer-attention enables the neural network to focus on relevant features of the network input by integrating different information across various levels of abstraction, and can thereby improve the performance (e.g., prediction accuracy) of the neural network. Moreover, using peer-attention can enable the neural network to achieve an acceptable level of performance over fewer training iterations, thereby reducing consumption of computational resources (e.g., memory and computing power) during training.

The peer-attention mechanism can be flexible and data-driven, e.g., because the attention weights (i.e., that govern the influence that each block exerts on the attention factors applied to the input channels of each other block) are learned, and because the attention factors are dynamically conditioned on the network input. The peer-attention mechanism can therefore improve the performance of the neural network more than a conventional attention mechanism, e.g., that can be hand-engineered or hard-coded.

The neural network can perform a video processing task by processing a multi-modal input that includes: (i) a set of video frames, (ii) optical flow frames that each correspond to an apparent movement of objects between two consecutive video frames, and (iii) segmentation maps that each correspond to a respective video frame and that define a segmentation of the video frame into one or more object classes. Processing the video frames, optical flow frames, and the segmentation maps enables the neural network to learn interactions between semantic object information and raw appearance and motion features, which can improve the performance (e.g., prediction accuracy) of the neural network compared to neural networks that do not process segmentation maps.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example neural network system.

FIG. 2 is a diagram of an example data flow illustrating the process for implementing peer-attention to generate the target block input for a target block.

FIG. 3 is a flow diagram of an example process for generating the target block input for a target block.

FIG. 4 is a flow diagram of example process for generating the attention factor for a respective first block output.

Like reference numbers and designations in the various drawings indicate like elements.

### DETAILED DESCRIPTION

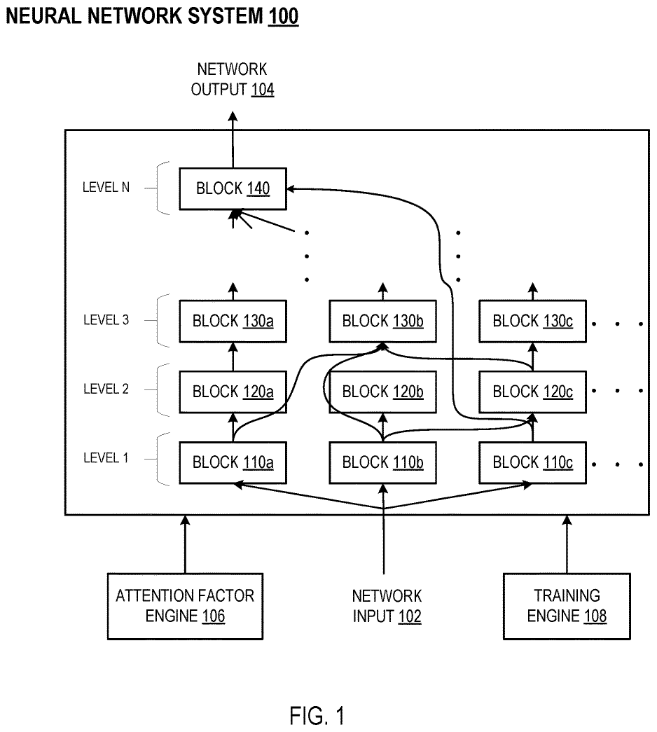

FIG. 1 shows an example neural network system 100. The neural network system 100 is an example of a system implemented as computer programs on one or more computers in one or more locations in which the systems, components, and techniques described below are implemented.

The neural network system 100 processes a network input 102 using one or more blocks arranged in levels to generate a network output 104 that characterizes the network input. The one or more blocks are arranged in an ordered sequence of levels such that each block belongs to only one of the levels. Each block of the one or more blocks is configured to process a block input using one or more neural network layers to generate a block output.

The neural network system 100 can be configured to process any appropriate network input, e.g., network input 102. The network input 102 can have space and time dimensions. For example, the network input can include a sequence of video frames, a sequence of optical flow frames corresponding to the sequence of video frames, a sequence of object segmentation maps corresponding to the sequence of video frames, or a combination thereof. In other examples, the network input can include representations of an image (e.g., represented by an intensity value or RGB values for each pixel in the image), an audio waveform, a point cloud (e.g., generated by a lidar or radar sensor), a protein, a sequence of words (e.g., that form one or more sentences or paragraphs), a video (e.g., represented in a sequence of video frames), one or more optical flow images (e.g., generated from a sequence of video frames), a segmentation map (e.g., represented by a one-hot encoding of an integer class value per pixel in an image, or per pixel in a video frame in a sequence of video frames, where each integer class value represents a different class of object), or any combination thereof.

The neural network system 100 can be configured to generate any appropriate network output, e.g., network output 104, that characterizes the network input. For example, the neural network output can be a classification output, a regression output, a sequence output (i.e., that includes a sequence of output elements), a segmentation output, or a combination thereof. Each level in the neural network system can include any appropriate number of blocks. The number of the blocks in each level and architectures of the blocks in each level can be selected in any appropriate way, e.g., can be received as input from a user of the system 100 or can be determined by an architecture search system. An example of an architecture search system for determining the respective number and architecture of blocks in each level is described in more detail with reference to PCT Application No. PCT/US2020/34267, which is incorporated by reference herein.

The neural network system 100 can be configured to have a variety of block types. That is, each block can have a respective combination of neural network layers, and respective neural network parameter values corresponding to the respective combination of neural network layers. A block can have any appropriate neural network architecture that enables it to perform its described function, i.e., processing a block input to generate a block output that characterizes the block input. In particular, a block can include any appropriate types of neural network layers (e.g., fully-connected layers, attention-layers, convolutional layers, etc.) in any appropriate numbers (e.g., 1 layer, 5 layers, or 25 layers), and connected in any appropriate configuration (e.g., as a linear sequence of layers).

For example, the system can have a variety of input blocks for level 1 (e.g., to process a variety of corresponding network input types), a variety of intermediate blocks, and one or more output blocks for the final level (e.g., to generate a variety of network outputs).

Each block can be a space-time convolutional block, i.e., a block that includes one or more convolutional neural network layers and that is configured to process a space-time input to generate a space-time output. Space-time data refers to an ordered collection of numerical values, e.g., a tensor of numerical values, which includes multiple spatial dimensions, a temporal dimension, and, optionally, a channel dimension. Each block can generate an output having a respective number of channels. Each channel can be represented as an ordered collection of numerical values, e.g., a 2D array of numerical values, and can correspond, e.g., to one of multiple filters in an output convolutional layer in the block.

Each block can include, e.g., spatial convolutional layers (i.e., having convolutional kernels that are defined in the spatial dimensions), space-time convolutional layers (i.e., having convolutional kernels that are defined across the spatial and temporal dimensions), and temporal convolutional layers (i.e., having convolutional kernels that are defined in the temporal dimension). Each block of the plurality of blocks can be, e.g., configured to process a block input at a respective temporal resolution.

Each block can include, e.g., one or more dilated temporal convolutional layers (i.e., having convolutional kernels that are defined in the temporal dimension, with a dilation factor equal to one for normal temporal convolutional layers, or with a dilation factor greater than one for dilated temporal convolutional layers). Each block's temporal dilation rate can correspond to the temporal resolution of the block.

The system described herein is widely applicable and is not limited to one specific implementation. However, for illustrative purposes, a small number of example implementations are described below.

In some implementations, the neural network can be configured to perform a video processing task. In these implementations, the neural network can process a network input that includes a sequence of multiple video frames, and optionally other data as well, e.g., a sequence of optical flow frames corresponding to the sequence of video frames, a respective segmentation map (e.g., including a class value for each pixel in the video frame) generated from each of the one or more video frames, or both.

In one example, the video processing task is an action classification task where the neural network generates an action classification output that includes a respective score for each action in a set of possible actions. The score for an action can characterize a likelihood that the video frames depict an agent, e.g., a person, an animal, or a robot, performing the action, e.g., running, walking, etc. In some cases, the action classification output includes a respective score for each action in a respective set of possible actions related to each of multiple classes of objects. The score for an action related to a particular object can characterize a likelihood that the video frames depict an agent, e.g., a person, an animal, or robot, performing the action with the object, e.g., that the agent is reading a book, speaking on a phone, riding a bicycle, driving a car, etc.

In another example, the video processing task is a super resolution task, e.g., where the neural network generates an output sequence of video frames having a higher spatial and/or temporal resolution than the input sequence of video frames.

In another example, the video processing task is an artefact removal task, e.g., where the neural network generates an output sequence of video frames that are an enhanced version of the input sequence of video frames that exclude one or more artefacts present in the input sequence of video frames.

In some implementations, the neural network can be configured to process an image to generate an object recognition output that includes a respective score for each object class in a set of possible object classes. The score for an object class can characterize a likelihood that the image depicts an object in the object class, e.g., a road sign, a vehicle, a bicycle, etc.

In some implementations, the neural network can be configured to process one or more medical images (e.g., magnetic resonance images (MRIs), computed tomography (CT) images, ultrasound (US) images, or optical coherence tomography (OCT) images) of a patient, to generate a network output characterizing the medical images. The network output can include, e.g.: (i) a respective referral score for each of a plurality of referral decisions that represents a predicted likelihood that the referral decision is the most appropriate referral decision for the patient, (ii) a respective condition score for each of one or more medical conditions that represents a predicted likelihood that the patient has the medical condition, (iii) a respective progression score for each of one or more condition states that represents a predicted likelihood that a state of a corresponding medical condition will progress to the condition state at a particular future time, and/or (iv) a respective treatment score for each of a plurality of treatments that represents a predicted likelihood that the treatment is the best treatment for the patient.

In some implementations, the neural network can be configured to process an observation (e.g., including one or more of an image, a sequence of video frames, a sequence of optical flow frames, etc.) characterizing a state of an environment to generate an action selection output that includes a respective score for each action in a set of possible actions that can be performed by the agent. The action to be performed by the agent can be selected using the action selection output, e.g., by selecting the action having the highest score. The agent can be, e.g., a mechanical or robotic agent interacting with a real-world environment, or a simulated agent interacting with a simulated environment.

Generally, the neural network system 100 has more than one block level. Each block level can have one or more blocks, and each block can include different neural network layer types. The neural network system 100 can include a variety of input blocks in level 1 (e.g., block 110a, block 110b, block 110c, and so on) to process network input 102, a variety of blocks in intermediate levels 2 through N-1 (e.g., blocks 120a, 120b, 120c, . . . in level 2, blocks 130a, 130b, 130c, . . . in level 3, and so on) to further process the block outputs from the input blocks, and an output block (e.g., block 140) in a final level N to generate network output 104. For example, the neural network system 100 can have a level 1 which includes a variety of input blocks to process a variety of input types, such as an input block to process raw RGB video input, an input block to process optical flow data characterizing the RGB video input, and an input block to process a segmentation map (e.g., generated for each of the video frames in the raw RGB video input). Each block input modality can be fed to multiple input blocks, e.g., a single raw RGB video input can go to multiple input blocks configured to process raw RBG video input.

The neural network can perform a machine learning task by processing a multi-modal input. For example, the neural network can perform a video processing task by processing (i) a set of video frames, and (ii) a respective segmentation map for each of the video frames that define a segmentation of the video frame into one or more object classes. The video processing task can include, e.g., an action classification task, e.g., identifying that an agent in the scene (e.g., a person, an animal, or a robot) is performing an action related to one of the object classes, e.g., reading a book, driving a car, riding a bicycle, or speaking on a phone. Processing both the video frames and the segmentation maps can enable the neural network to learn interactions between semantic object information and raw appearance and motion features, which can improve the performance (e.g., prediction accuracy) of the neural network compared with neural networks that do not process segmentation maps.

The neural network system 100 processes the network input using input blocks in the first level, and generates the block input for each block in each level after the first level by processing the block output of one or more respective blocks from preceding levels. Generally, for each given block that is associated with a given level that follows the first level in the sequence of levels, the given block only receives block outputs from other blocks that are associated with levels that precede the given level. The connections between blocks are shown using arrows in FIG. 1. That is, the arrows shown represent that the output of one block is provided to another block. For example, to generate the block input for target block 130b, the system can process the block output from block 110a, block 110b, and block 120c. The connections between blocks can skip levels, such as block output from block 110c contributing to the block input for target block 140.

Each block output includes a set of channels. A channel can be represented by an ordered collection of numerical values, e.g., a vector or matrix of numerical values. For example, a block output can have multiple output channels, each output channel in the block output corresponding to a different convolutional filter in the block.

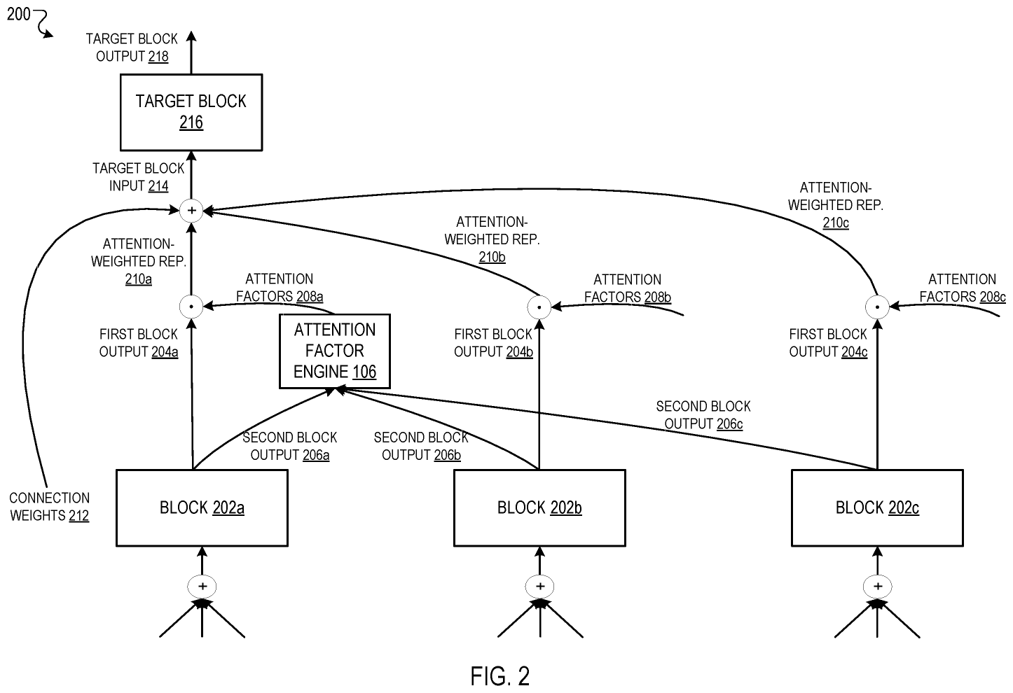

The system 100 can generate the respective block input for some or all of the blocks after the first level using “peer-attention.” The system implements peer-attention using an attention factor engine 106, as will be discussed in more detail below with reference to FIG. 2.

The neural network system 100 has a set of neural network parameters. The system can update the neural network parameters using the training engine 108.

The training engine 108 can train the neural network system 100 using a set of training data. The set of training data can include multiple training examples, where each training example specifies: (i) a training input to the neural network, and (ii) a target output that should be generated by the neural network by processing the training input. For example, each training example can include a training input that specifies a sequence of video frames and/or a corresponding sequence of optical flow frames, and a target classification output, e.g., that indicates an action being performed by a person depicted in the video frames. The training engine 108 can train the neural network system 100 using any appropriate machine learning training technique, e.g., stochastic gradient descent, where gradients of an objective function are backpropagated through the neural network at each of one or more training iterations. The objective function can be, e.g., a cross-entropy objective function, or any other appropriate objective function.

It will be appreciated that the neural network system 100 can be trained for video processing tasks other than classification tasks by a suitable selection of training data and/or loss function. For example, the neural network system 100 can be trained for super resolution (in the spatial and/or temporal domain) using a training set comprising down-sampled videos and corresponding higher-resolution ground-truth videos, with a loss function that compares output of the neural network to a higher-resolution ground-truth video corresponding to the down-sampled video input to the neural network, e.g. an L1 or L2 loss. As a further example, the neural network system 100 can be trained to remove one or more types of image/video artefact from videos, such as blocking artefacts that can be introduced during video encoding. In this example, the training dataset can include a set of ground truth videos, each with one or more corresponding “degraded” videos (i.e. with one or more types of artefact introduced), with a loss function that compares output of the neural network system 100 to a ground-truth video corresponding to the degraded video input to the neural network system 100, e.g. an L1 or L2 loss.

FIG. 2 shows a diagram of an example data flow 200 illustrating the operations performed by a neural network system implementing peer-attention to generate the block input for a block, referred to for convenience as a “target” block, in any level after the first level. That is, a target block can refer to any block after the first level of blocks. An example of a neural network system, e.g., neural network system 100, that can perform the operations of data flow 200 is described in more detail above with reference to FIG. 1.

The system generates the target block input for a target block by processing a respective block output of each of one or more other blocks to generate a combined representation of the respective block outputs. The target block can then process the combined representation as the target block input to generate a target block output.

The system receives a respective block output of each of one or more “first” blocks (e.g., first block outputs 204a, 204b, and 204c from blocks 202a, 202b, and 202c, respectively), where each first block can come from any level preceding the target level of the target block. (For convenience, each block that provides a block output to the target block will be referred to as a first block.) The first block outputs each include multiple channels, and each is generated by a respective first block during processing of a network input, e.g., the network input 102 of FIG. 1. For example, each channel in a respective first block output can correspond to a filter in a convolutional layer in the respective first block.

For each first block output, the system generates a respective attention factor for each channel of the first block output by processing a respective block output of each of one or more “second” blocks, where at least one of the respective second blocks is different from the first block. (For convenience, each block that generates a block output that is used for generating attention factors to be applied to the channels of a first block output will be referred to as a “second” block). Each second block output comes from a block in a level preceding the target level of the target block. Generally, the set of second block outputs processed to generate the attention factors for one first block output can be different from the set of second blocks processed to generate the attention factors for another first block output.

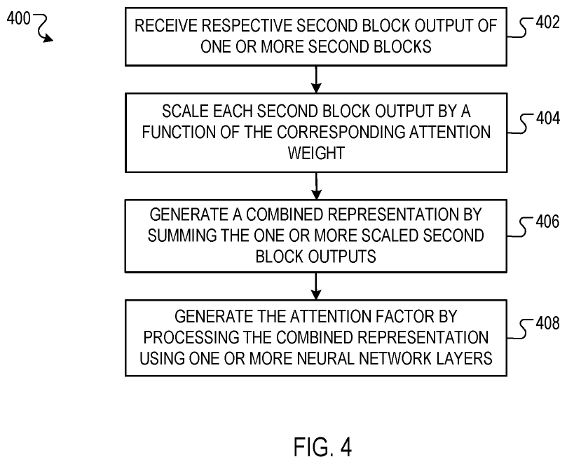

The system can generate the respective attention factors from the one or more second block outputs using an attention factor engine 106. For example, the attention factor engine can generate a combined representation of the respective second block outputs, and process the combined representation to generate the respective attention factors, as is discussed in further detail with reference to FIG. 4. With reference to FIG. 2, the respective second block outputs processed to generate respective attention factors 208a for first block output 204a are shown (i.e., second block outputs 206a, 206b, and 206c). For convenience, the respective second block outputs processed to generate attention factors 208b (i.e., for first block output 204b) and the respective second block outputs processed to generate attention factors 208c (i.e., for first block output 204c) are omitted from the diagram. An attention factor can be represented by a numerical value, e.g., a floating point numerical value. A set of attention factors for a block output can be represented by a collection of ordered numerical values (e.g., a vector of floating point numerical values), where each value corresponds to a channel of the block output.

For each first block output, the system generates an attention-weighted representation of the first block output. The system can generate the attention-weighted representation of the first block output by applying each attention factor to the corresponding channel of the first block input. For example, the system can generate the attention-weighted representation by scaling each channel of the first block output by the corresponding attention factor. With reference to FIG. 2, the system applies attention factors 208a to first block output 204a to generate attention-weighted representation 210a, attention factors 208b to first block output 204b to generate attention-weighted representation 210b, and attention factors 208c to first block output 204c to generate attention-weighted representation 210c.

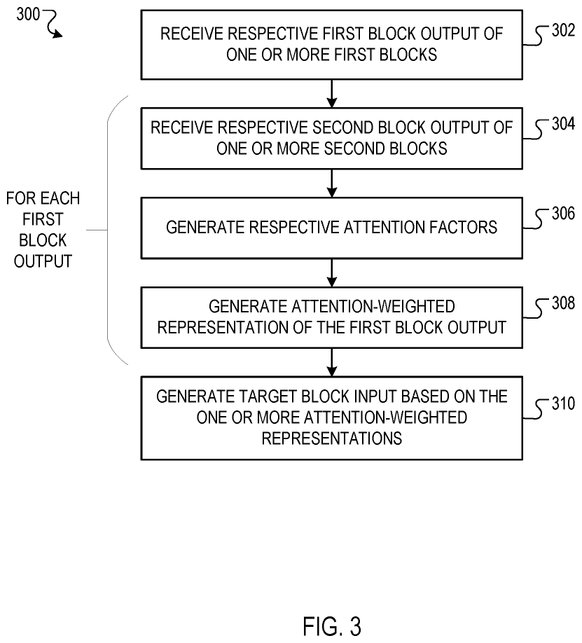

The system generates the target block input 214 by processing the attention-weighted representations 210a, 210b, and 210c. The system can generate the target block input 214 by generating a combined representation of the attention-weighted representations. For example, the system can generate a weighted sum of the attention-weighted representations using a set of connection weights 212, as is discussed in further detail with reference to FIG. 3. With reference to FIG. 2, the system generates the target block input 214 by scaling each attention-weighted representation by a function of the corresponding weight in the connection weights 212, then summing the scaled attention-weighted representations.

The target block 216 processes the target block input 214 to generate a target block output 218 that characterizes the target block input 214. Generally, the target block output 218 has multiple channels. In some cases, the target block output 218 can be processed as either a respective first block output, a respective second block output, or both, for one or more target blocks in subsequent levels. In another case, the target block 216 can process the target block 214 such that the target block output 218 is the network output.

FIG. 3 is a flow diagram of an example process for generating the target block input for a target block. For convenience, the process 300 will be described as being performed by a system of one or more computers located in one or more locations. For example, a neural network system, e.g., the neural network system 100 of FIG. 1, appropriately programmed in accordance with this specification, can perform the process 300.

The system receives a respective first block output of one or more first blocks (302). Each first block can be from any level preceding the target level of the target block. For example, for a target block in level 5 of a neural network system, the system can receive respective first block outputs from first blocks in levels 1, 2, 3, 4, or any combination thereof

For each first block output, the system implements a “peer-attention” mechanism, i.e., where the outputs of one or more second blocks (where at least one of the second blocks is different from the first block) in the neural network are processed to generate a set of attention factors that are applied to the channels of the first block output, as is described in steps 304-306. For convenience, a second block providing output to generate the attention factors for a first block output will be referred to as an “attention connection.”

For each first block output, the system receives a respective second block output of each of one or more second blocks (304), where at least one of the second blocks is different than the first block. Each second block can be in any level preceding the target level of the target block. For example, for a target block in level 5 and a first block in level 2, a second block can be in levels 1, 2, 3, or 4.

For each first block output, the system generates respective attention factors (306). The system can generate an attention factor for each channel of the first block output by processing the one or more second block outputs. For example, the system can generate a combined representation of the one or more second block outputs, and process the combined representation using one or more neural network layers to generate the attention factors for the first block output, as is discussed in further detail with reference to FIG. 4.

Generally, the outputs of different blocks in the neural network can encode different information at various levels of abstraction. Using peer-attention enables the neural network to focus on relevant features of the network input by integrating different information across various levels of abstraction, and can thereby improve the performance (e.g., prediction accuracy) of the neural network. Moreover, using peer-attention can enable the neural network to achieve an acceptable level of performance over fewer training iterations, thereby reducing the consumption of computational resources (e.g., memory and computing power) during training.

For each first block output, the system generates an attention-weighted representation of the first block output (308). The system can generate an attention-weighted representation of the first block output by applying each attention factor to the corresponding channel of the first block output. For example, the system can scale each channel of the first block output by the corresponding attention factor using an elementwise multiplication, as

Xⱼ^{att}=Aⱼ·Xⱼ^{out}, (1)

where j indexes the first blocks, Xⱼ^{att} represents the attention-weighted representation of the first block output, Aⱼ represents the attention factors corresponding to the first block output, and Xⱼ^{out} represents the respective first block output of the first block j.

The system generates the target block input for a target block based at least in part on the attention-weighted representations of the first block outputs (310). For example, the system can generate the target block input based on a weighted sum of the attention-weighted representations of the first block outputs using a set of connection weights, e.g., connection weights 212 in FIG. 2, as

Xᵢⁱⁿ=Σ_{j∈P(i)}σ(wⱼᵢ)·Xⱼ^{att}, (2)

where i indexes the target block, j indexes the first blocks, Xᵢⁱⁿ represents the target block input, Xⱼ^{att} represents the attention-weighted representation of the first block output of first block j, σ(.) represents the sigmoid function, wⱼᵢ represents the connection weight from block j to block i, and P(i) returns all j for first blocks contributing to the target block i. The connection weights are learnable parameters which can be trained, e.g., by training engine 108 of FIG. 1.

Generally, any block can receive a block output from any block in a preceding level, and the blocks can be connected in any appropriate way. In some implementations, the blocks can be initially fully connected, i.e., such that each block in each level provides its block output to each block in each subsequent level. During training of the neural network, the respective connection weight associated with each block connection is trained, and optionally, some of the block connections can be removed (“pruned”) during or after training. For example, the system can optionally remove any connections having a connection weight that is less than a predefined value, or the system can remove a predefined number of connections having connection weights with the lowest values.

FIG. 4 is a flow diagram of an example process for generating the attention factors for a respective first block output. For convenience, the process 400 will be described as being performed by a system of one or more computers located in one or more locations. For example, an attention factor engine, e.g., the attention factor engine 106 of FIG. 1, appropriately programmed in accordance with this specification, can perform the process 400.

The system receives a respective second block output of each of one or more second blocks (402). Each second block can be from any level preceding the target level of the target block. For example, if the target block is from level 3, the second blocks can be from level 1, level 2, or a combination of the two.

The system scales each second block output by a function of a corresponding attention weight (404). The corresponding attention weights are learnable parameters which can be trained, e.g., by training engine 108 of FIG. 1, and each attention weight corresponds to a second block output. In one example, the system can apply a softmax function to the attention weights corresponding to each second block output, then scale each second block output by the corresponding attention weight output by the softmax function. Using a softmax function can emphasize the contribution of the most impactful second block or blocks.

The system generates a combined representation of the scaled second block outputs (406). For example, the system can represent the combined representation as,

X^{com}=Σ_{k∈Q9I)}softmaxₖ(H)·Xₖ^{out}, (3)

where i indexes the target block, k indexes the second blocks, X^{com} represents the combined representation of second block outputs, Xₖ^{out} represents a respective second block output of a second block k, H represents a vector including a respective attention weight for each second block output, softmaxₖ (H) represents the k-th component of the softmax of the vector H, and Q(i) return all k for second blocks contributing to the combined representation. The attention weights are learnable parameters which can be trained, e.g., by training system 108 of FIG. 1.

Generally, any block can receive a second block output from any number of second blocks in preceding levels, i.e., by respective attention connections, for use in generating an attention-weighted representation of a first block output. In some implementations, the system can initialize the blocks as fully connected with attention connections, i.e., such that for any block that processes a block input generated by peer-attention, the attention-weighted representation of each first block output is generated using every feasible second block output. During training of the neural network, the respective attention weights associated with each attention connection are trained, and optionally, some of the attention connections can be removed (“pruned”) during or after training. For example, the system can optionally remove any attention connections having an attention weight that is less than a predefined value, or the system can remove a predefined number of attention connections with the lowest attention weight values.

The peer-attention mechanism can be flexible and data-driven, e.g., because the attention weights are learned, and because each the attention factors are dynamically conditioned on the network input. The peer-attention mechanism can therefore improve the performance of the neural network more than a conventional attention mechanism, e.g., that can be hand-engineered or hard-coded.

The system generates the attention factors by processing the combined representation using one or more neural network layers (408). For example, the system can process the combined representation using a global average pooling layer over the spatial dimensions of each channel, followed by a fully-connected layer, and an elementwise sigmoid function, as

Aⱼ=τ(f(GAP(X^{com}))), (3)

where j indexes the first blocks, Aⱼ represents the attention factors for the first block j, σ(.) represents the elementwise sigmoid function, f represents the fully connected neural network layer, GAP(.) represents the global average pooling, and X^{com} represents the combined representation of the second block outputs. The fully connected layer outputs a vector with a number of elements equal to the number of channels of the corresponding first block output.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more data processing apparatus for processing a network input using a neural network to generate a network output, wherein the neural network comprises a plurality of blocks that each include one or more respective neural network layers, wherein each block is configured to process a respective block input to generate a respective block output, the method comprising, for each of one or more target blocks of the neural network:
generating a target block input to the target block, comprising:
receiving a respective first block output of each of one or more respective first blocks, wherein each first block output comprises a plurality of channels, wherein the first block outputs are generated by the first blocks during processing of the network input by the neural network;
generating a respective attention-weighted representation of each first block output, comprising, for each first block output:
receiving a respective second block output of each of one or more second blocks, wherein at least one of the second block outputs is different than the first block output, wherein the second block outputs are generated by the second blocks during processing of the network input by the neural network;
processing the second block outputs to generate a respective attention factor corresponding to each channel of the first block output; and
generating the attention-weighted representation of the first block output by applying each attention factor to the corresponding channel of the first block output; and
generating the target block input from at least the attention-weighted representations of the first block outputs; and
processing the target block input using the target block to generate a target block output.

2. The method of claim 1, wherein processing the second block outputs to generate a respective attention factor corresponding to each channel of the first block output comprises:
generating a combined representation by combining the second block outputs using a set of attention weights, wherein each attention weight corresponds to a respective second block output;
processing the combined representation using one or more neural network layers to generate the respective attention factor corresponding to each channel of the first block output.

3. The method of claim 2, wherein generating the combined representation by combining the second block outputs using the set of attention weights comprises:
scaling each second block output by a function of the corresponding attention weight; and
determining the combined representation based on a sum of the scaled second block outputs.

4. The method of claim 2, wherein processing the combined representation using one or more neural network layers to generate the respective attention factor corresponding to each channel of the first block output comprises:
processing the combined representation using a pooling layer that performs global average pooling over spatial dimensions of the combined representation; and
processing an output of the pooling layer using a fully connected neural network layer.

5. The method of claim 2, wherein values of the attention weights are learned during training of the neural network.

6. The method of claim 1, wherein generating the attention-weighted representation of the first block output by applying each attention factor to the corresponding channel of the first block output comprises:
scaling each channel of the first block output by the corresponding attention factor.

7. The method of claim 1, wherein generating the target block input from at least the attention-weighted representations of the first block outputs comprises:
combining the attention-weighted representations of the first block outputs using a set of connection weights, wherein each connection weight corresponds to a respective attention-weighted representation of a first block output.

8. The method of claim 7, wherein combining the attention-weighted representations of the first block outputs using the set of connection weights comprises:
scaling each attention-weighted representation of a first block output by a function of the corresponding connection weight.

9. The method of claim 7, wherein values of the connection weights are learned during training of the neural network.

10. The method of claim 1, wherein:
each block in the neural network is associated with a respective level in a sequence of levels; and
for each given block that is associated with a given level that follows a first level in the sequence of levels, the given block only receives block outputs from other blocks that are associated with levels that precede the given level.

11. The method of claim 10, wherein the target block is associated with a target level, and the target block receives: (i) a respective first block output of each first block that is associated with a level that precedes the target level, and (ii) a respective second block output of each second block that is associated with a level that precedes the target level.

12. The method of claim 1, wherein the neural network performs a video processing task.

13. The method of claim 12, wherein the network input comprises a plurality of video frames.

14. The method of claim 13, wherein the network input further comprises data defining one or more segmentation maps, wherein each segmentation map corresponds to a respective video frame and defines a segmentation of the video frame into one or more object classes.

15. The method of claim 13, wherein the network input further comprises a plurality of optical flow frames corresponding to the plurality of video frames.

16. The method of claim 14, wherein the neural network comprises a plurality of input blocks, wherein each input block includes one or more respective neural network layers, wherein the plurality of input blocks comprise: (i) a first input block that processes the plurality of video frames, and (ii) a second input block that processes the one or more segmentation maps.

17. The method of claim 12, wherein each block of the plurality of blocks is configured to process a block input at a respective temporal resolution.

18. The method of claim 17, wherein each block comprises one or more dilated temporal convolutional layers having a temporal dilation rate corresponding to the temporal resolution of the block.

19. (canceled)

20. (canceled)

21. A system comprising:
one or more computers; and
one or more storage devices communicatively coupled to the one or more computers, wherein the one or more storage devices store instructions that, when executed by the one or more computers, cause the one or more computers to perform operations for processing a network input using a neural network to generate a network output, wherein the neural network comprises a plurality of blocks that each include one or more respective neural network layers, wherein each block is configured to process a respective block input to generate a respective block output, the operations comprising, for each of one or more target blocks of the neural network:
generating a target block input to the target block, comprising:
receiving a respective first block output of each of one or more respective first blocks, wherein each first block output comprises a plurality of channels, wherein the first block outputs are generated by the first blocks during processing of the network input by the neural network;
generating a respective attention-weighted representation of each first block output, comprising, for each first block output:
receiving a respective second block output of each of one or more second blocks, wherein at least one of the second block outputs is different than the first block output, wherein the second block outputs are generated by the second blocks during processing of the network input by the neural network;
processing the second block outputs to generate a respective attention factor corresponding to each channel of the first block output; and
generating the attention-weighted representation of the first block output by applying each attention factor to the corresponding channel of the first block output; and
generating the target block input from at least the attention-weighted representations of the first block outputs; and
processing the target block input using the target block to generate a target block output

22. One or more non-transitory computer storage media storing instructions that when executed by one or more computers cause the one or more computers to perform operations for processing a network input using a neural network to generate a network output, wherein the neural network comprises a plurality of blocks that each include one or more respective neural network layers, wherein each block is configured to process a respective block input to generate a respective block output, the operations comprising, for each of one or more target blocks of the neural network:
generating a target block input to the target block, comprising:
receiving a respective first block output of each of one or more respective first blocks, wherein each first block output comprises a plurality of channels, wherein the first block outputs are generated by the first blocks during processing of the network input by the neural network;
generating a respective attention-weighted representation of each first block output, comprising, for each first block output:
receiving a respective second block output of each of one or more second blocks, wherein at least one of the second block outputs is different than the first block output, wherein the second block outputs are generated by the second blocks during processing of the network input by the neural network;
processing the second block outputs to generate a respective attention factor corresponding to each channel of the first block output; and
generating the attention-weighted representation of the first block output by applying each attention factor to the corresponding channel of the first block output; and
generating the target block input from at least the attention-weighted representations of the first block outputs; and
processing the target block input using the target block to generate a target block output.
